(19) United States
(12) Patent Application Publication
(10) Pub. No.: US 2007/0283327 A1
(43) Pub. Date: Dec. 6, 2007

(54) HIERARCHICAL TEST VERIFICATION USING AN EXTENDABLE INTERFACE

(75) Inventors: Satish Mathew, Redmond, WA (US); Mehmet Demir, Redmond, WA (US); Kaushik Pushpavanam, Sammamish, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/422,043

(22) Filed: Jun. 2, 2006

(51) Int. Cl. G06F 9/44

(52) U.S. Cl. 717/124

(57) ABSTRACT

Embodiments provide for a pluggable framework for testing a product by creating a command test application program interface (API) layer that supports hierarchical verification. These test APIs provide well written wrappers around commands so that a product tester can start writing test cases quickly and at good code quality. Verification of command execution is broken into two parts. The high level first stage verification is handled by an embodied framework; the detailed second stage is delegated back to the pluggable tester that initiated the test. This final stage of verification verifies that the specific properties of the item are valid. It is up to the tester to decide how granular the second stage should be. Accordingly, other embodiments provide for progressive development, which indicates that the specific verifications do not need to be enforced by the framework and can be added over time in the development process.

### CROSS-REFERENCE TO RELATED APPLICATIONS

N/A

### BACKGROUND

Most software is developed as a number of reusable software objects, each designed to carry out one or more tasks. The utility and functionality of the software, as well as the computing system running the software, depend on the proper coding of the source code that is compiled or interpreted for execution by a processor. Coding errors usually cause a deviation from expected functionality of the software and potentially may impact other parts of the computer system (e.g., other applications, databases, the operating system, etc.) Such coding errors not only frustrate the user's computing experience with the software, but can also cause undesired effects throughout the computer system. Therefore, producers of high-quality software expend significant testing and analysis efforts to eliminate errors in their software.

Currently, test developers write separate rules for different levels of software verification, i.e., the amount of analysis that each rule performs when determining if an object or piece of code passed or failed. Verification levels for rules that test software vary widely depending on myriad factors. Accordingly, there is generally a tradeoff between the amount of time consumed in running a rule or test case and how thoroughly the software is tested. In particular, the less outputs that are generated and analyzed, the less time consuming the testing becomes. For example, a test developer may write rules for simply testing the stress or load of the software. In such a case, the resulting outputs of the test case may be ignored and the object or targeted code is considered to have passed if the software or system doesn't crash. While this form of analysis allows for a quick test of the software, it does not provide a complete determination of all the effects caused by the software. As such, there is usually much debate and consideration needed in determining the verification level necessary for each rule to appropriately analyze the software.

One growing area of concern in the testing analysis is the amount of time spent generating and executing tests for various extensions and plug-ins of existing applications. More and more, software applications are become highly extensible by using interfaces between two independent components, which allows these unrelated objects to communicate with each other. Often times, the extensions or plug-ins to the existing application share a common interface so they are expected to have similar behavior, but they differ in specifics of how they behave. Due to these behavioral differences, it is difficult for these components to share the same set of test cases or testing interface. As such, the test developer needs to write test cases that iterate through all various combinations of the supported commands in a product and test each scenario for a specific extension or plug-in. This process must then be repeated for every new product that extends to or plugs into the existing application; possessing a lengthy time period to exhaustively generate and execute all test combinations involved in testing the multiple products.

### BRIEF SUMMARY

The above-identified deficiencies and drawback of current testing systems are overcome through example embodiments of the present invention. For example, embodiments described herein provide for an expandable hierarchical testing verification and progressive development of extensions and/or plug-ins. Note that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One example embodiment provides for minimizing test efforts by providing a scaleable testing framework that allows for hierarchical testing verification. A call is received from a tester to initiate a test for a command of a product. Note that specific properties of the command are not known to a test application program interface (API) that receives the call. Nevertheless, based on the test initiated, a generic test case is started that provides a high level first stage verification by calling operation(s) for verifying common behaviors for the command, which are consistent among the plurality of commands such that they each inherent the generic test case from the API, but specific properties of the plurality of commands differ across them.

Further note, however, that these specific properties of the command are not needed to give this high level first stage verification. If needed, however, the verification of the specific properties for the command are delegated back to the tester that initiated the test for extending the generic test case within the test API with the detailed second stage of verification in order to allow for multilevel test verification. In one embodiment, however, there is no requirement for enforcing this second stage in order to allow for full progressive development of a product.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantageous features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a test application program interface configured to perform hierarchical test verification and progressive development in accordance with example embodiments; and

FIG. 2 illustrates a flow diagram for a method of minimizing testing efforts by providing a scaleable testing framework in accordance with example embodiments.

### DETAILED DESCRIPTION

The present invention extends to methods, systems, and computer program products for providing a scalable testing framework that allows for multilevel test verification and progressive development of extensions and/or plug-ins. The embodiments of the present invention may comprise a special purpose or general-purpose computer including various computer hardware or modules, as discussed in greater detail below.

As previously mentioned, product extensions or plug-ins will often have common behaviors, but vary in the specific properties for each component. For example, a “new-file” command and “new-printer” command may share the same common behavior of creating a new item (i.e., a file or a printer); however, the specific properties of each will be quite different. More specifically, the properties of the new-file such as file type, name, state (e.g., open, closed, etc.), will be quite different from the specific properties of the new-printer, which may include printer status, default printer properties, current queue length, etc. It is these differences in the specific properties or behaviors that create a problem in efficiently testing existing and new products or extensions with minimal effort. Nevertheless, both the file and printer will have some common properties such as existence, creation time, path, name, etc.

Accordingly, embodiments provide for a pluggable framework for testing a product by creating a command test application program interface (API) layer that supports hierarchical verification. Generic test cases are created for the above APIs to test common behaviors across multiple commands or components. These test APIs provide well written wrappers around commands so that a product tester can start writing test cases quickly and at good code quality. For such commands, the API tester contains several wrappers that execute the command of a product and check post-conditions to command execution including: (a) generic verification, which verifies behavior that should be consistent across components that inherent from the same interface; and (b) specific user verification, which verifies the specific behavior or properties of a component that differ from other components that share the same interface.

In other words, verification of command execution is broken into two parts. The high level first stage verification is handled by an embodied framework; the detailed second stage is delegated back to the pluggable tester that initiated the test. Commands that perform modification of properties such as state of an object can be verified by the operations corresponding to the generic test cases. For example, a new-item operation can be verified by its associated “getter”, the get-item operation. The get-item operation verifies the existence of item created by new-item. Similarly, a remove-item operation or command can be verified by running get-item to ensure that the item does not exist. This is part of the first stage of verification, which uses the expected common or general behavior in the product or command to verify it.

The second stage of the verification is then delegated to the product tester through the use of callback functions or interfaces that the product tester might implement. This final stage of verification verifies that the item is in the correct state or that the properties of the item are valid. It is up to the tester to decide how granular the final verification stage should be. For example, in the new-file command, the specific properties verified could be the file type and file attributes, whereas for new-C printer command, the specific properties could be the actual printer status. Accordingly, other embodiments provide for progressive development, which indicates that the specific verifications do not need to be enforced by the framework and can be added over time for the development of the various products.

As will be described in greater detail below, exemplary embodiments provided for mechanisms that minimize the test effort for various extensions and/or plug-ins by creating a test framework that allows for hierarchical verification that can be extended by individual test cases and progressive development. Accordingly, embodiments solve the test scalability issue of an interface or common interface through a hierarchically verification that provides a framework that includes multiple levels of verification to allow differentiation of behavior across the implementers of common interface. Progressive development, on the other hand, provides that the framework does not enforce specific verification to be available in order to run such tests.

Also note the tremendous costs savings associated with the testing mechanisms described herein. For example, if a single base case has numerous derived test cases, adding one test case to the base adds value to each derived test case. Further, bugs discovered in one derived test case can help contribute a new base test case; thus bring up the quality of the other components. In addition, there is also uniformity from this testing system, which results in making it cognitively easier for an end-user to comprehend.

Although more specific reference to advantageous features are described in greater detail below with regards to the Figures, embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

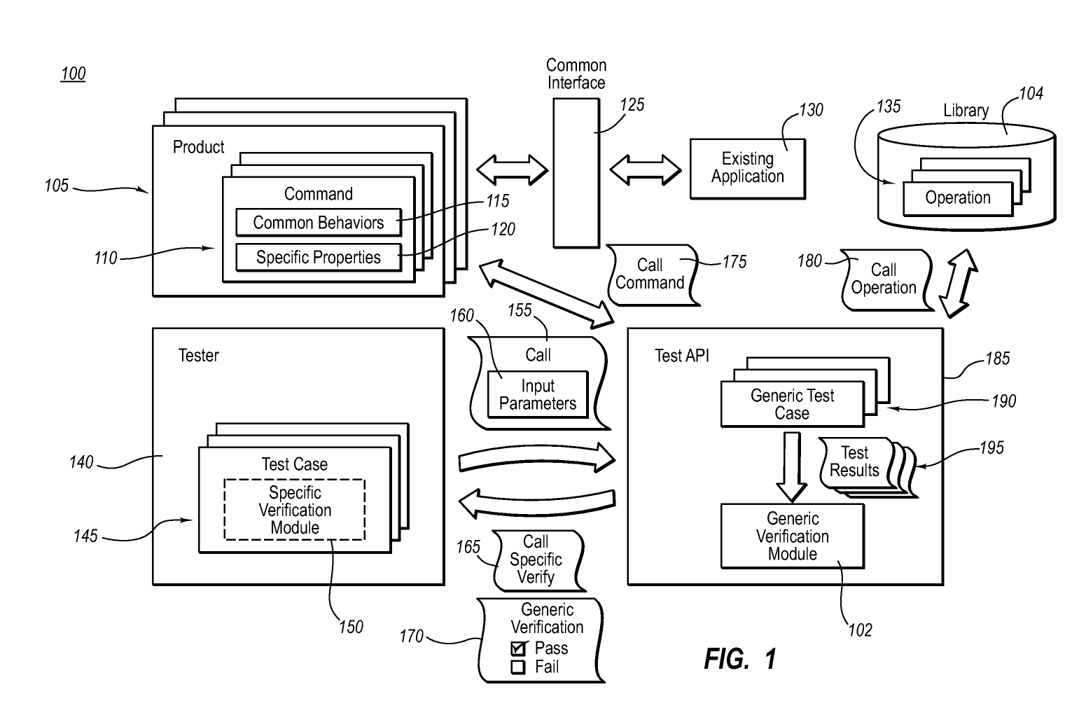

FIG. 1 illustrates a computing system (100) configured to test products using a scalable testing framework that allows for hierarchical testing verification and progressive development in accordance with example embodiments. As shown, products (105) (e.g., extensions or plug-ins) with various commands (110) use a common interface (125) in order to communicate with an existing application (130). Note that that application (130) and the products (105) thereto may be any well known applications and extensions and/or plug-ins. For example, application (130) may be a command shell application that has product (105) extensions. Products (105) can define a set of very specific base classes and interfaces. These classes may help give a user a common look and feel when interacting with different data stores, such as a file system, registry, or an active directory. Developers, however, can create new products (105) that can be added to the command shell application (130) for any various functionality or extension.

Further, it should be noted that the commands (110) can be any well known function or operation. Note that as used herein the terms “function”, “operation”, and “command” are used interchangeably to refer to the functionality of a corresponding piece of software (e.g., application (130), product (105), etc.). Nevertheless, the products (105) use a common interface (125) to communicate with the application (130) based on common behaviors (115) that appear across multiple such commands (110) or products (105). Note, however, that the specific properties (120) for these products (105) or commands (120) will vary.

For example, a set of commands (110) may include commands for moving a car, plane, or animal. Each of these commands (110) will share a common behavior (115) of “move”; however, the specific properties (120) for how they move will differ. More specifically, the car, plane, or animal are capable of changing position from point “A” to point “B”; however, the specifics for speed, velocity, and how they move are all very different. Nevertheless, because these “move” commands (110) share common behaviors (115), they are configured to use a common interface (125) to generally communicate with the existing application (130).

Note that although the above commands (110) for “move” were used, there are other numerous commands (110) with common behaviors (115) that vary in the specific properties (120). In addition, there are various products (105) that can have any number of various commands (110) communicate with any various application (130) that also includes a myriad of operations. Accordingly, any particular use of a particular product (105), command (110), operation, function, application(130), common behaviors (115), specific properties (120), etc., as used herein are for illustrative purposes only and are not meant to limit or otherwise narrow embodiments unless otherwise explicitly claimed.

As previously noted, developers can create new products (105) that can be added to or extend the existing application (130); however, a problem exists as to how to efficiently test the existing application (130) along with the new products (105) with minimal effort. As mentioned above, a simple approach may be to iterate through all of the various combinations of the supported commands (110) in a product (105) and test each scenario for a specific product (105). This process may then be repeated for every new product (105) that is added to the application (130). Such technique, however, posses a lengthy time period to finish testing multiple products (105) and is very difficult to exhaustively test all combinations involved.

Accordingly, embodiments provide for a test application program interface (API), which includes a pluggable framework for testing products (105) that support hierarchical verification. Generic test cases (190) are created for use with such test API (185), which provides a common interface used across multiple components or commands (110) for testing common behaviors (115). Note that this test API (185) may be the same interface as common interface (125) described above. In fact, as will be appreciated, any of the various modules and components described herein can be combined in any manner to perform many of the various function described herein. Accordingly, the aesthetic layout of FIG. 1 and the particular functionality and behaviors of various components or modules as described herein, are for illustrative purposes only and is not meant to limit or otherwise narrow the scope of embodiments described herein.

Regardless of the aesthetic layout and overall functionality of the various components shown in FIG. 1, test API (185) will provide wrappers around operations (135) that can be used by the tester (140) when starting to write test cases (145) quickly and at a good code quality. In other words, the tester (140) uses the generic test cases (190) as a starting point in creating test cases (145) for particular product (105) or command (110). Note that although the tester (140) appears separate from the individual products (105), typically the tester (140) will be included as part of the overall product (105). In any event, tester (140) includes a set of test cases (145) for verifying the functionality of one or more commands (110). In support of the hierarchical verification described herein, tester (140) makes a call (155) to the test API (185) for initiating a generic test case (190).

Note that the call (155) will typically include input parameters (160) such as an identifier for the command (110) under test. Nevertheless, the test API (185) will not need specific properties (120) in order to appropriately verify the common behaviors (115) of the command (110). In fact, as will be described in greater detail below, embodiments support progressive development of products, which means that the framework does not enforce verification of specific properties (120) in order to run the generic test cases (190). Accordingly, regardless of the type of input parameters (160), generic test case (190) will call (180) various operations (135) from operation library (104 for testing the common behaviors (115) of commands (110). These operations (135) will typically be included as part of the test API (185) or as part of the overall existing application (130).

In addition to call operations (180), the test API (185) will call (175) the commands (110) for execution by the various products (105). As previously noted, the commands include common behaviors (115) consistent among a plurality of commands (110) and/or products (105), as well as specific properties (120) that differ among them. For example, if the command (110) is a “new-file” command that generates or creates a file, a call (155) from the tester (140) will initiate a generic test case (190) for testing the command (110). Note that the test API (185) will not have any information regarding specifics properties (120) associated with the command (110) when running the generic test cases (190). Nevertheless, the generic test case (190) can make a call operation (180) for invoking various options (135) used in verifying the common behaviors. For instance, in this example, call operation (180) may invoke a “get operation” (135) for identifying that the new file does not currently exist. Next, the test API (185) can make a call command (175) to the product (105) for invoking the new-file command (110), which should create the file. The test API (185) then makes the call operation (180) again for invoking another get operation (135), wherein if the new-file command (110) executed properly the get operation (135) should return the true.

Note that there may also be other generic tests (190) other than simply testing the existence or absence of an item that executed. For example, the test API (185) may determine if after execution of the command (110) whether or not errors occurred or exceptions where raised. Of course, as will be recognized, there are many other generic test cases (190) and operations (135) used for load and other testing that can be ran for quickly determining if the common behaviors (115) of a command (110) appropriately executed. Accordingly, the example generic test cases (190) described herein are for illustrative purposes only and are not meant to limit or otherwise narrow embodiments described herein unless otherwise explicitly claimed.

Regardless of the type, generic test cases (185) and operations (135) used to verify the appropriate command (110), test results (195) of a generic state can be passed to the generic verification module (102) for validation. For example, in the above example, the common behaviors (115) of the command (110) were verified by returning the test results (195) showing that the get operation (135) for the command of new file (110) properly executed. As such, generic verification module (102) can generate a generic verification (170) indicating that the generic test case (190) passed, and relay this back to the tester (140).

Note that in some embodiments, all that is needed is this high level first stage of verification for a tester to be (140) satisfied that the test case (145) appropriately verified the command (110). As such, embodiments provide for a progressive development that allows the tester (140) to control the granularity at which the specific properties (120) of the command (110) can be tested. In other words, in one embodiment, tester (140) can consider the test to be complete, provided that the generic tests (190) where ran and produced appropriate results (195) of pass or fail (170). Other embodiments, however, provide that the specific properties (120) or verification thereof can be delegated back to the tester (140) for a test case (145) using a specific verification module (150). That is, specific verification module (150) may or may not be implemented as indicated in the dotted outline of such module.

In the event that the verifications of the specific properties (120) are desired to be tested, test API (180) can make a callback (using call specific verify (165)) to the tester in order to implement specific verification module (150). In other words, callbacks (165) are made from the test API (185) when delegating the verification of the specific properties (120) for the command (110) back to the tester (140). The test case (145) can then include various coding written by the test developer for controlling the specific granularity to which the specific properties (120) will be tested.

For example, in the case given above for the new-file command (110), the specific state and properties of a file can be delegated back to the test case (145) designed specifically for that particular command (110). In other words, this second stage of verification is delegated to the specific test case (145), which verifies that the item is in the correct state and/or that the specific properties (120) of the item are valid. Accordingly, the generic test cases (190) are extended by the second detailed stage of verification, thereby providing for a hierarchical verification that can be extended by individual plug-in tests (145). It is up to the tester (145), however, to decide how granular the final verification stage should be.

Also note that as new products (105) and/or commands (110) with similar common behaviors (115) are developed, these new products (105) automatically inherit the generic test cases (190). For example, a product (105) may be developed with a “new-printer” command (110) that includes the same or similar common behaviors (115) of the above new-file command (110). Accordingly, the generic test case (190) that utilizes the “get” operation (135) can be used for the high level first stage of testing the new-printer in a similar manner as that described above for the new-file generic testing. As such, the developer does not need to write code (other than a simple call (155)) for the generic test cases (190), and all of these are automatically and quickly inherited from the previous setup for the new-file (or other command).

In addition, embodiments allow for the control of the granularity for testing specific properties (120) or for the progressive development, which indicates that specific verifications (150) need not be enforced by the framework or a test API (185) and could be added in time. More specifically, as the tester (140) or test developer wishes, and as the products (105) are developed over time, more and more specific properties (120) can be tested for the various commands (110) as desired and needed. This allows for a high level generic test case (190) to be ran quickly, at early stages in the development process of the products (105), and delaying the specific properties (120) verification for later development stages.

The following pseudo code illustrates an example test case (145) and an example test API (185) used for verifying a command (110) of a “remove-item”. Of course, other encoding mechanisms are also contemplated herein. Further, the following pseudo code uses proprietary naming and other features. Nevertheless, any specific encoding mechanism and/or APIs shown are used herein for illustrative purposes only and are not meant to limit or otherwise narrow embodiments described herein.

Example Test Case:

```
/// <summary>
/// Removes a valid Item
/// </summary>
public virtual void PTFRemoveItemPathValidItemExistsTest(ItemTestData
testData, Collection<bool>parameterList, IGetItemVerifier
specificGetItemVerifier)
{
  //CREATE TEST API INSTANCE
  ItemTestingIntrinsics Item = new ItemTestingIntrinsics(this,
specificGetItemVerifier);
  ....
  try
  {
    testData.Setup( );
    bool doPostVerifications = true;
    ItemTestData newTestData = new ItemTestData(itemFullPathList,
String.Empty, testData.Type, testData.Value);
    newTestData.Force = parameterList[0];
    newTestData.Recurse = parameterList[1];
    //Generic test case calling test API.
    Item.Remove(newTestData, doPostVerifications);
  }
  finally
  {
    testData.Cleanup( );
  }
}
```

As noted in the example test case above, a command (110) is provided that removes a valid item. The example test case then creates a test API instance by calling the initiation of a generic test case (190) within the test API (185).

Example Test API:

```
namespace Test.Management.Automation.ProviderTestingFramework
{
/// <summary>
/// Test API for item noun related operations
/// </summary>
/// <remarks>
/// ItemTestingIntrinsics provides the test API for item noun operations. It contains
functions that wrap all of the
/// operations done by *-item commands and also provides some other item related
functions. Each function has the
/// ability to perform known pre-condition and post-condition verifications.
/// </remarks>
public class ItemTestingIntrinsics : IItemTestAPI
{
  #region Private Data
  private CommandShellApplicationTestFixture monadTestFixture;
  private PTFUtilities Utilities;
  private PathTestingIntrinsics Path;
  private IGetChildItemVerifier getChildItemVerifier;
  private IClearItemVerifier clearItemVerifier;
  private IGetItemVerifier getItemVerifier;
  private LocationTestingIntrinsics Location;
  #endregion
  #region Constructors
  /// <summary>
  /// Constructor for ItemTestingIntrinsics
  /// </summary>
  public ItemTestingIntrinsics(CommandShellApplicationTestFixture
commandshellTestFixture, IGetItemVerifier userSuppliedGetItemVerifier)
  {
    ...
    getItemVerifier = userSuppliedGetItemVerifier;
    ...
  }
  #endregion
  #region get-item
  /// <summary>
  /// Test wrapper around get-item operation/command in the product
  /// </summary>
  /// <param name=“testData”></param>
  /// <param name=“doPostVerifications”></param>
  /// <returns></returns>
  public ExecutionResult Get(TestData testData, bool doPostVerifications)
  {
    ....
    //EXECUTE COMMAND OPERATION
    Utilities.ExecuteProductCommandAndVerifyException(coreCommand, null, out
outputList, out errorList, parameterList.ToArray( ), expectedExceptionType,
doPostVerifications);
    ExecutionResult result = new ExecutionResult(outputList, errorList);
    //START POST-VERIFICATIONS
    if (doPostVerifications && expectedExceptionType == null)
    {
      //GENERIC VERIFICATION OF ERRORS
      monadTestFixture.AssertErrorObjectsOfType(errorList, expectedErrorType);
      //Output is only valid if the errors collections is empty
      if (errorList.Length == 0)
      {
        /********Check if the results returned are not EMPTY *********/
        Assertion.AssertNotEquals(outputList.Length, 0, String.Format(“The
results returned from the command ( {0} ) should not be EMPTY”, coreCommand));
        //START CUSTOM VERIFICATION
        if (getItemVerifier != null)
        {
          .....
          //CALL CUSTOM VERIFICATION PROVIDED BY SPECIFIC
PROVIDER TESTER
          getItemVerifier.VerifyGetItem(getData, result);
        }
      }
      else
      {
        ....
      }//end if (errors.Length==0)
    }
    return result;
  }
  #endregion get-item
  #region remove-item
  /// <summary>
  /// Test wrapper around remove-item operation/command in the product
  /// </summary>
  /// <param name=“testData”></param>
  /// <param name=“doPostVerifications”></param>
  public ExecutionResult Remove(TestData testData, bool doPostVerifications)
  {
    ....
    //EXECUTE COMMAND OPERATION
    Utilities.ExecuteProviderCmdletAndVerifyException(“remove-item”, null, out
outputList, out errorList, parameterList.ToArray( ), expectedExceptionType,
doPostVerifications);
    //START POST-VERIFICATIONS
    if (doPostVerifications && expectedExceptionType == null)
    {
      //GENERIC VERIFICATION OF ERRORS
      monadTestFixture.AssertErrorObjectsOfType(errorList, expectedErrorType);
      /********Check if the results returned are EMPTY *********/
      //No output, since remove-item operation does not Output any results
      Assertion.AssertEquals(outputList.Length, 0, “The results returned should be
of zero length, since there is an error”, Severity.One);
      //Output is only valid if the errors collections is empty
      if (errorList.Length == 0)
      {
        //bool doPostVerification = true;
        ItemTestData getTestData = new ItemTestData( );
        getTestData.Path = itemPaths;
        getTestData.Include = includePattern;
        getTestData.Exclude = excludePattern;
        getTestData.Filter = filterPattern;
        //GENERIC VERIFICATION: USE GET OPERATION/COMMAND IN
THE TEST API TO VERIFY REMOVE
        MshObject[ ] getResult = Get(getTestData, false).Results;
        Assertion.AssertEquals(getResult.Length, 0, “remove target still exists post-
operation. Declarin tactical alert.”);
      }
    }
    return new ExecutionResult(outputList, errorList);
  }
  #endregion remove-item
}//end class ItemTestingIntrinsics
} // end namespaceTest.Management.Automation.ProviderTestingFramework
```

Note that when calling the generic test case (190) within the example test API (185) above for item testing, a “get” operation (135) is first used to verify that the item being removed currently exists. The next part of the pseudo code for the test API (185) then executes the command operation using a call command (175) calling back into the product (105) for removing that particular item. As such, in the next section of the pseudo code for post verifications for generic test cases (190) can begin. As a first set of generic verifications, errors are identified such that any errors may be returned to the tester (140). As shown, the next generic verifications includes calling the get operation again wherein if the remove command or item (110) properly executed the output should be zero indicating a valid execution. As shown next in the pseudo code, the custom verification may use a call back (165) to the test case (145) for implementing any specific verification of properties (120), if any.

As will be appreciated, as new commands with similar behaviors are developed, test cases for these new commands or products can also use or inherent the generic cases using the test API (185). For example, if there is a new “remove-printer” command created, the tester (140) with the specific test case (145) for the remove-printer can use the generic test cases (190) described above for validating at a high level the first stage in the hierarchical testing described herein. Any specific properties (120) for verification should be delegated in a second stage back to the tester (140) for implementation by a specific verification module (150). Also returned to the tester (140) should be any generic verifications (170) giving indications as to those that have passed and failed.

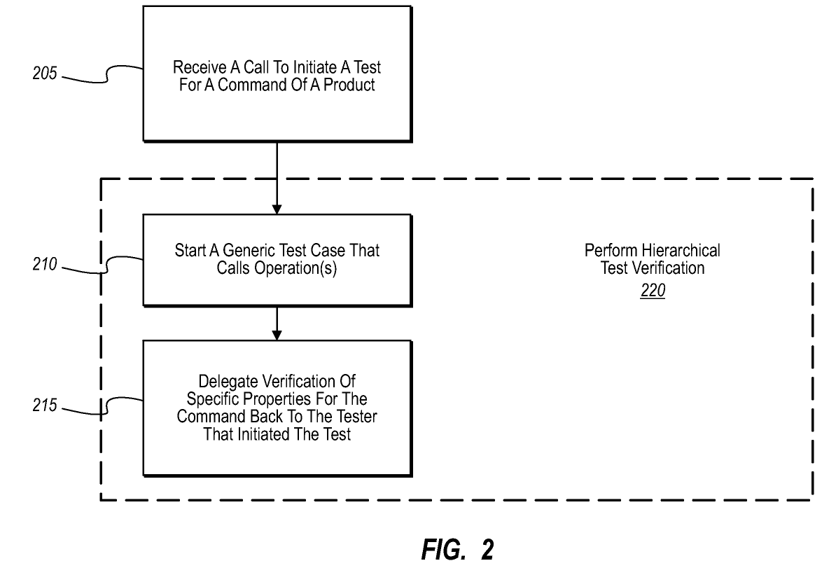

The present invention may also be described in terms of methods comprising functional steps and/or non-functional acts. The following is a description of steps and/or acts that may be performed in practicing the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use of steps and/or acts in the recitation of the claims—and in the following description of the flow diagram for FIG. 2—is used to indicate the desired specific use of such terms.

As previously mentioned, FIG. 2 illustrates a flow diagram for various exemplary embodiments of the present invention. The following description of FIG. 2 will occasionally refer to corresponding elements from FIG. 1. Although reference may be made to a specific element from this Figure, such references are used for illustrative purposes only and are not meant to limit or otherwise narrow the scope of the described embodiments unless explicitly claimed.

FIG. 2 illustrates a flow diagram of method (200) for minimizing testing efforts by providing a scaleable testing framework that allows for hierarchical testing verification. Method (200) includes an act of receiving (205) a call to initiate a test for a command of a product. For example, test API (185) may receive a call (155) from tester (140) for initiating a generic test case (190). Note that the call (155) can include input parameters (160) that define such things as the specific command (110) that is to be called by the test API (185) and various other input parameters that may be used. Note, however, that the specific properties (120) (e.g., state of the command (110)) do not need to be included since the test API (185) does not need to know of these specifics in order to appropriately implement the generic test cases (190). Nevertheless, the input parameters (160) may include an indication as to whether or not the specific verification (150) will be delegated back to the tester (140) of the specific test case (145) for the command (110) or product (105).

Note that the product (105) may be an extension and/or plug-in that generally shares a common interface (125) with a plurality of other products (105) for communicating with an existing application (130). For instance, the existing application (130) may be a command shell that provides a common set of base classes to give a common look and feel when interacting with different data store. These data stores may include a file system, registry, active directory, etc.

Method (200) also includes a step for performing the hierarchical test verification (220). For example, step for (220) includes an act of starting (210) a generic test case that calls operations. For example, test API (185) can start a generic test case (190) that provides a high-level first stage verification by calling (180) various operations (135) for verifying common behaviors (115) for the command (110). Note that the common behaviors (115) of the command (110) are consistent among a plurality of commands (110) such that each inherent the generic test case (190) from the test API (185), but specific properties (120) of the plurality of commands (110) differ across them. Such generic test cases (190) may determine if exceptions or errors occur, or the presence and/or absence of an item corresponding to the command.

For instance, a get operation (135) may be used for testing the common behaviors (115) of a new-file command (110), new printer command (110), or any other similar command or function that inherits the generic test case (190) from the test API (185) or has common behaviors (115) that are consistent among the various commands (110). Upon execution of the new-file or new-printer command (110), generic test case (190) can check for errors or exceptions, and the existence of the file or printer created. Note, however, the specific properties (120) of the new-file and new-printer will vary, as described above.

Further, step for (220) includes an act of delegating (215) verification of specific properties for the command, back to the tester that initiated the test. For example, test API (185) can determine if any specific properties (120) for the command (110) are needed to be verified. If they are, specific verification module (150) can be initiated by making a callback (165) to the test case (145) of the tester (140). Note that in such instance, the generic test cases (190) are extended through the use of this delegation of specific verifications back to the tester (140). On the other hand, embodiments do not require the specific verification in order to allow a user or developer to determine a granularity for which testing verification is desired. In other words, other embodiments also provide for a progressive development framework that allows for the high-level first stage to quickly verify the common behaviors (115), while testing of the specific properties (120) can be delayed for testing further in the development process.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a computer system configured to test a plurality of functions with similar behaviors using a common interface, a method of minimizing testing efforts by providing a scalable testing framework that allows for hierarchical testing verification, the method comprising:
receiving, from a tester, a call to initiate a test for a command of a product, wherein one or more specific properties of the command are not known to a test application program interface (API) that receives the call;
based on the test initiated, starting a generic test case that provides a high level first stage verification by calling one or more operations for verifying one or more common behaviors of the command, which are consistent among a plurality of commands such that they each inherent the generic test case from the API, but specific properties of the plurality of commands differ across them; and
delegating verification of the one or more specific properties for the command back to the tester that initiated the test for extending the generic test case within the test API with a detailed second stage of verification in order to allow for multilevel test verification.

2. The method of claim 1, wherein the product is an extension, plug-in, or both, that generally shares a common interface with a plurality of other products for communicating with an existing application.

3. The method of claim 2, wherein the existing application is a command shell that provides a common set of base classes to give a common look and feel when interacting with different data stores.

4. The method of claim 3, wherein the different data stores include one or more of a file system, registry, or active directory.

5. The method of claim 1, wherein the one or more specific properties include a state of the command.

6. The method of claim 1, wherein at least one of the one or more operations called by the generic test case executes the command of the product under test.

7. The method of claim 1, further comprising:
receiving a call to initiate the test for a second command of a second product, wherein the one or more common behaviors for the command are consistent among the second command;
based on the test request, starting the generic test case by calling the one or more operations for verifying the one or more common behaviors for the second command; and
determining that one or more specific properties for second command are not to be tested such that only the high level first stage verification is executed.

8. The method of claim 1, wherein the call to initiate the test includes one or more input parameters that identify the command in order to allow the generic test case to initiate the command during the high level first stage verification.

9. The method of claim 1, wherein the generic test case determines if one or more of the following occurs: an exception; an error; or a presence, absence, or both, of an item corresponding to the command.

10. In a computer system configured to test a plurality of functions with similar behaviors using a common interface, a method of reducing test time costs by providing a progressive development framework that allows for the sharing of the generic test cases without enforcing verification of the specific properties, the method comprising:
receiving, from a tester, a call to initiate a test for a command of a product, wherein one or more specific properties of the command are not known to a test application program interface (API) that receives the call;
based on the test initiated, starting a generic test case that provides a high level first stage verification by calling one or more operations for verifying one or more common behaviors for the command, which are consistent among a plurality of commands such that they each inherent the generic test verification from the API, but specific properties of the plurality of commands differ across them; and
determining if specific verification of the one or more specific properties is needed, wherein if such specific verification is needed the method further includes:
delegating specific verification of the one or more properties for the command back to the tester that initiated the test for extending the generic test case within the test API with a detailed second stage of verification in order to allow for multilevel test verification, otherwise the method includes:
allowing the high level first stage to quickly verify the one or more common behaviors of the command without requiring the specific verification in order to allow a user to determine a granularity for which testing verification is desired.

11. The method of claim 10, wherein the product is an extension, plug-in, or both, that generally shares a common interface with a plurality of other products for communicating with an existing application.

12. The method of claim 11, wherein the existing application is a command shell that provides a common set of base classes to give a common look and feel when interacting with different data stores.

13. The method of claim 12, wherein the different data stores include one or more of a file system, registry, or active directory.

14. The method of claim 10, wherein the call to initiate the test includes one or more input parameters that identify the command in order to allow the generic test case to initiate the command during the high level first stage verification.

15. The method of claim 10, wherein the generic test case determines if one or more of the following occurs: an exception; an error; or a presence, absence, or both, of an item corresponding to the command.

16. In a computer system configured to test a plurality of functions with similar behaviors using a common interface, a computer program product for implementing a method of minimizing testing efforts by providing a scalable testing framework that allows for hierarchical testing verification, the computer program product comprising one or more computer-readable media having stored thereon computer-executable instructions that, when executed by one or more processors of the computing system, cause the computing system to perform the following:
receive, from a tester, a call to initiate a test for a command of a product, wherein one or more specific properties of the command are not known to a test application program interface (API) that receives the call;
based on the test initiated, start a generic test case that provides a high level first stage verification by calling one or more operations for verifying one or more common behaviors of the command, which are consistent among a plurality of commands such that they each inherent the generic test case from the API, but specific properties of the plurality of commands differ across them; and
delegate verification of the one or more specific properties for the command back to the tester that initiated the test for extending the generic test case within the test API with a detailed second stage of verification in order to allow for multilevel test verification.

17. The computer program product of claim 16, wherein the product is an extension, plug-in, or both, that generally shares a common interface with a plurality of other products for communicating with an existing application.

18. The computer program product of claim 16, further comprising:
receiving a call to initiate the test for a second command of a second product, wherein the one or more common behaviors for the command are consistent among the second command;
based on the test request, starting the generic test case by calling the one or more operations for verifying the one or more common behaviors for the second command; and
determining that one or more specific properties for second command are not to be tested such that only the high level first stage verification is executed.

19. The computer program product of claim 16, wherein the call to initiate the test includes one or more input parameters that identify the command in order to allow the generic test case to initiate the command during the high level first stage verification.

20. The computer program product of claim 16, wherein the generic test case determines if one or more of the following occurs: an exception; an error; or a presence, absence, or both, of an item corresponding to the command.
